(19) United States
(12) Patent Application Publication
(10) Pub. No.: US 2014/0324255 A1
(43) Pub. Date: Oct. 30, 2014

(54) AIRCRAFT EMERGENCY SYSTEM USING ADS-B

(71) Applicants: Shahid Siddiqi, Poquoson, VA (US); Richard A. Weiss, Port Orange, FL (US)

(72) Inventors: Shahid Siddiqi, Poquoson, VA (US); Richard A. Weiss, Port Orange, FL (US)

(21) Appl. No.: 14/215,393

(22) Filed: Mar. 17, 2014

Related U.S. Application Data
(60) Provisional application No. 61/787,732, filed on Mar. 15, 2013.

(51) Int. Cl. B64D 25/00

(52) U.S. Cl. CPC B64D 25/00
USPC 701/14

(57) ABSTRACT

A safety system for an aircraft using ADS-B has a touch screen device or switch interfaced with an emergency computer, wherein the emergency computer sends an emergency signal to the ADS-B system in response to a command from the touch screen device or switch.

### FIELD OF THE INVENTION

The present invention relates to an emergency system for use in aviation. More particularly, the present invention relates to an affordable emergency system, which integrates with ADS-B to facilitate recovery of an aircraft with an incapacitated or distressed pilot or an unmanned aerial vehicle (UAV) with a broken data link.

### BACKGROUND OF THE INVENTION

Safety and the safety systems for the purpose of avoiding disaster have long been of interest in the field of aviation. One area of concern relates to the problem arising when a pilot or flight crew has become incapacitated or distressed. Incapacitation of the pilot or crew flying the aircraft is likely to quickly lead to a serious safety problem. Another problem may arise where a pilot becomes distressed by flying into instrument conditions without adequate instrument flying proficiency. These kinds of situations are of particular concern where the aircraft involved is carrying passengers who are not pilots. Another area of increasing concern is that of controlling unmanned aerial vehicles (UAVs) which have lost communication or data links with a ground controller. While UAVs can be programmed to proceed automatically to a predetermined point should such an event occur, there can be an issue regarding conflicts with other aircraft or flight into bad weather.

One approach for dealing with pilot incapacitation involves provision of an automatic aircraft control system. For example, U.S. Pat. No. 8,255,098 Aug. 28, 2012 to Jones et al. for VARIABLY MANNED AIRCRAFT discloses a system which includes a plurality of subsystems cooperatively configured to control an aircraft after pilot incapacity. Another example is disclosed in U.S. Pat. No. 8,200,379 Jun. 12, 2012 to Manfredi et al. for SMART RECOVERY SYSTEM. This patent discloses Senate intelligence system onboard an aircraft that detects said emergency, assesses the situation, and then acts on the situation in a predetermined manner. Still another example is disclosed in U.S. Pat. No. 6,507,776 Jan. 14, 2003 for AUTOPILOT FOR AIRCRAFT HAVING AUTOMATIC DESCENT FUNCTION IN THE EVENT OF CABIN DEPRESSURIZATION.' These patents show the concern for passengers of aircraft with an incapacitated flight crew but require systems which are sophisticated and designed for larger, turbine, turbojet or propjet aircraft. However, many of the aircraft flying in the United States and other countries are smaller aircraft, referred to as General Aviation (GA) aircraft. Thus, it would be beneficial to have a system designed for smaller GA, piston engine aircraft.

It also would be beneficial to have a safety system, which is designed to integrate with present-day and future modern air traffic control radar and tracking as well as communication systems. For example, the so-called next generation air transportation system (NextGen) uses automatic dependent surveillance broadcast (ADS-B) technology to maintain continuous communication between aircraft and ground-based facilities. It is believed that ADS-B will be crucial in the future for the many different types of aviation vehicles including GA aircraft, recreational aircraft, unmanned aerial vehicles, airline and commuter airline aircraft, military aircraft, and helicopters. NextGen establishes automatic tracking or position reporting communication aircraft to aircraft as well as between aircraft and air navigation service provider (ANSP) controllers.

In accordance with the present invention, an Automatic Dependent Surveillance Broadcast Emergency Response (ADS-B-ER) system is provided. The system of the present invention is particularly well suited for use with smaller piston driven aircraft. However, the ADS-B-ER system is also adaptable for use with the aforementioned other types of aviation vehicles using airspace.

Further understanding of the present invention will be had from the following specification and claims taken in conjunction with the accompanying drawings.

### BRIEF DESCRIPTION OF THE DRAWINGS

FIG. 1 is a block diagram of a preferred embodiment of an ADS-B-ER system of the present invention with an optional autopilot:

FIG. 2 is a block diagram illustrating the steps of a preferred method of the ADS-B-ER of this invention:

FIG. 3 is a drawing showing the initial display of a touchscreen display of either a portable or installed display device of the preferred embodiment of FIG. 1;

FIG. 4 is a drawing showing an intermediate display of a touchscreen display of a portable display device of the preferred embodiment of FIG. 1; and

FIG. 5 is a block diagram of an alternative preferred embodiment of an ADS-B-ER system of the present invention without an autopilot.

### SUMMARY OF THE INVENTION

An ADS-B-ER safety system for an aircraft having an ADS-B system, the ADS-B-ER system having an activation device such as a touch screen, a designated button or switch in the aircraft which is interfaced with an emergency computer, wherein the emergency computer sends an emergency signal to the ADS-B system in response to a command from the device. In one preferred embodiment the ADS-B-ER system sends navigation instructions to the autopilot. In another preferred embodiment, the ADS-B-ER system provides voice, or voice and video, coaching for non-pilot passengers or a distressed pilot.

### DESCRIPTION OF THE INVENTION

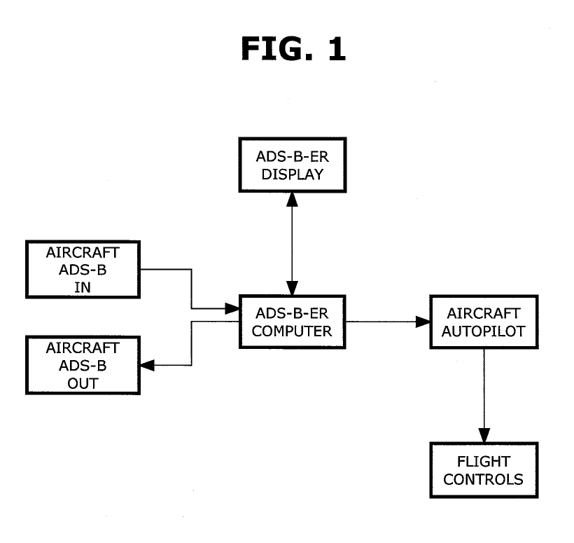

Now referring to FIG. 1, a preferred embodiment of an ADS-B-ER system of the present invention is shown and illustrated in block diagram form in FIG. 1. The ADS-B-ER system functions in operative association with an aircraft's ADS-B (Automatic Dependent Surveillance Broadcast) system which is in use in the United States and other countries to enhance Air Traffic Control (ATC) and surveillance of aircraft. Of course, those skilled in the art will appreciate that while a preferred embodiment of the present invention is illustrated in FIG. 1 and described herein, the present invention is subject to modifications and variations within the broad scope of the invention.

As illustrated in FIG. 1, ADS-B-ER is intended to be carried aboard an aircraft and used in conjunction with the aircraft's ADS-B system. Generally speaking, and as illustrated in FIG. 1, the ADS-B-ER system comprises an ER-computer which is in communication with the aircraft's autopilot, an ADS-B-ER portable or installed display incorporating an activation switch and the aircraft's ADS-B system.

The ER computer is preferably a small footprint microcomputer with a commercial Internet wireless transmitter and with Bluetooth wireless capability and USB connectivity. Suitable computers are available commercially.

The autopilot is that autopilot which is installed in the aircraft and is preferably a two or three axis autopilot with a command module which will allow programming of the autopilot by the ER-computer.

The ADS-B-ER portable display is preferably a commercially available, off the shelf mobile tablet such as is available from Apple, Samsung, and other manufacturers or an Android, Apple or Windows operating system smart phone. A preferred tablet has a touch screen and although the activation switch may be separate from the display, the switch is preferably activated by touching a touch screen display of a suitable tablet.

The aircraft's ADS-B system is that ADS-B system on board the aircraft. The ADS-B system can be an ADS-B UAT system or an ADBS-B Mode S ES system. The ADS-B system includes an IN receiver and an OUT transmitter and requires a standard or WAAS GPS which is interfaced to the ADS-B OUT.

In use, it is contemplated that the ADS-B-ER system will be used as follows.

Before flight, the passenger(s) are briefed on operation or use of the ADS-B-ER system. For example, the briefing may include how to recognize an emergency situation arising due to incapacitation of the flight crew and how to respond to it by using the ADS-B-ER system.

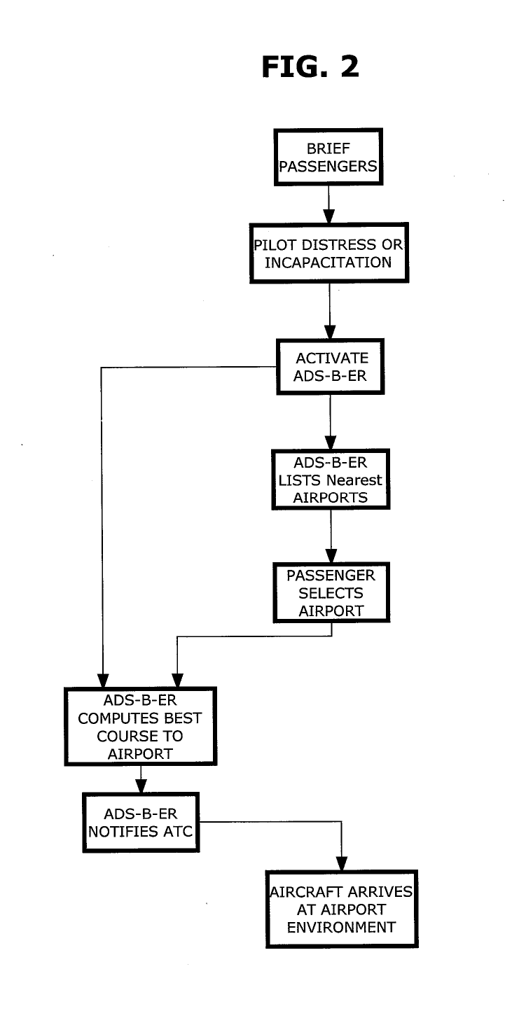

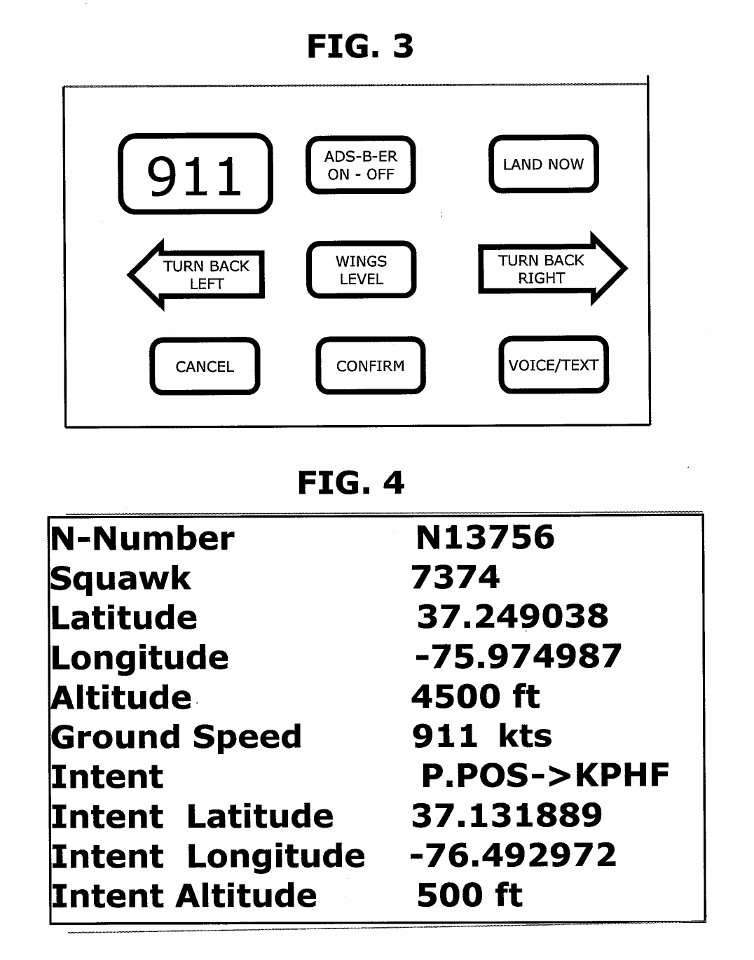

As is illustrated in FIGS. 2 and 3, in the event of identification of an incapacitation emergency, it is intended that one or more of the passengers will identify the emergency situation and decide to act. A passenger presses the red 911 button on the ADS-B-ER display (which can be a tablet or other suitable display device as illustrated in FIG. 3) or activates a designated switch (which may be a button switch or any other suitable switch) and the 911 numerals now flash. The passenger (or distressed pilot) then presses the confirm button on the portable display and it lights up to confirm the emergency situation. If the 911 button had been pressed by mistake the passenger can press the cancel button on the portable display instead of the confirm button.

The ADS-B-ER embedded software on the ADS-B-ER computer now performs computations: (A) to create a list of the four Nearest Airports available in the GPS based navigation software being used on the mobile device; and (B) to compute the optimum trajectory flight path to the nearest suitable airport and, if desired, the computer can be programmed to automatically select an airport. The airports are highlighted by flashing icons on the mobile device or moving map display and/or a tabular list of the airports is displayed. Of course, the software can be programmed to create a list of more or less than four nearest airports if desired. The optimum flight path to the nearest suitable airport is selected to avoid hazardous weather (if weather information is available to the computer), terrain, traffic and restricted airspace.

The desired airport destination is selected by the passenger or distressed pilot or by the computer itself and then the emergency computer instructs the aircraft's autopilot to direct the aircraft to the airport. If the aircraft does not have an autopilot or if it is desired in addition to the autopilot, the emergency computer can connect to a suitable device such as the portable display to provide voice or text or video coaching or instructions to the passenger(s) or distressed pilot as is illustrated in FIG. 5.

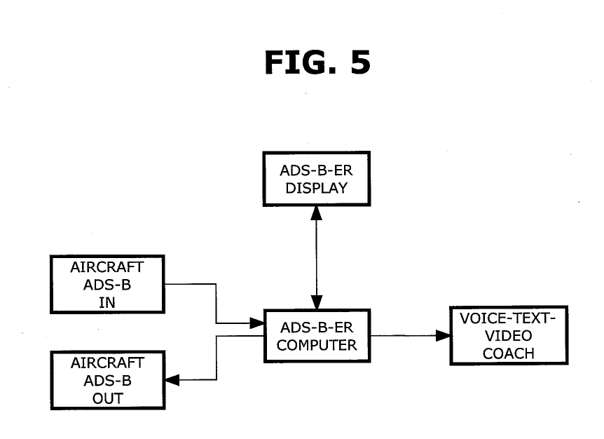

The FAA's NextGen ATC controllers are notified there is an emergency or Mayday situation in the following way: the ground speed data block in the standard format ADS-B message is set to 911 knots triggering an alert. The ADS-B-ER route destination coordinates are sent out as the Intent Data in the standard ADS-B-OUT message format as shown in text form in FIG. 4. Based upon this information, a series of 911 telephone calls can be made automatically by the ADS-B-ER computer or by the controllers thru the ground emergency network to alert first responders. The controllers can simultaneously track the aircraft and guide other aircraft traffic away from it and offer other suitable assistance.

The FAA's NextGen controllers now know the destination and can monitor the emergency situation, they have the option to modify the proposed nearest airport by another ADS-B-ER operational concept.

As illustrated in FIG. 3, the tablet can have a screen which offers additional options. For example, where the situation may not call for a 911 emergency such as where a distressed non-instrument capable pilot has entered instrument flight conditions, it may not be necessary for the pilot to press the 911 button. A Land Now button is provided if the pilot/passenger wants to land now at a nearby airport just wants to get on the ground as soon as possible. Also, buttons can be provided for Turn Back Left and Turn Back Right to provide the option of returning left or right to a last safe waypoint rather than just a traditional 180 degree turn where a pilot enters unwanted instrument conditions. The aircraft automatically returns to the previous navigation waypoint and continues via the reversed route in the navigation system. If there is no available route the computer can be programmed to simply execute a 180 degree heading or course reversal. A Wings Level button can be provided to maintain the aircraft straight and level until the Cancel button is selected.

While the present invention has been described in terms of a preferred embodiment thereof, it will be appreciated by those skilled in the art that the invention is subject to variation and modification within the broad scope of the invention. For example various types of display devices may be used and may be portable or fixedly installed in the aircraft. Also, the invention can be readily adapted to aircraft which are piloted from the ground such as UAVs or other aircraft which are computer controlled rather than pilot controlled. Unmanned/remotely piloted aircraft that are in distress can be provided with an on-board computer capable of detecting certain faults such as lost communications or a communication receiver capable of receiving a specific activation signal from another system on-board or of being activated by the remote pilot on the ground; the emergency is then activated using the ADS-B-ER system. Therefore, the present invention is intended to be limited only by the scope of the appended claims.

What is claimed is:

1. A safety system for a piloted aircraft having an ADS-B system and an autopilot, the safety system having activation device interfaced with an emergency computer, wherein the emergency computer sends an emergency signal to the ADS-B system in response to a command from the activation device.

2. A safety system as in claim 1 wherein said emergency signal is the airspeed 911 knots.

3. A safety system as in claim 1 wherein said emergency computer is in communication with a weather service.

4. A safety system as in claim 3 wherein said activation device is a tablet with a touch screen which is wirelessly interfaced with said computer.

5. A safety device as in claim 4, wherein said touch tablet is in Bluetooth communication with said computer.

6. A safety device as in claim 1 wherein said activation device is a switch.

7. A safety device as in claim 1 wherein said aircraft has an autopilot and said emergency computer is in communication with said autopilot.

8. A safety device as in claim 1 wherein said emergency computer is in communication with a display capable of presenting information to an occupant of said aircraft.

9. A Safety device as in claim 1 wherein said emergency computer is in communication with an audio device capable of presenting information to an occupant of said aircraft.

10. A method for handling an emergency situation in an aircraft when control of said aircraft has become in jeopardy because of incapacitation or distress of the aircraft's pilot, the method comprising the steps of:
identifying an incapacitation emergency;
sending a signal to an emergency computer on board the aircraft;
using said computer to compute a desired course to a nearby airport;
using ADS-B to notify ATC that an emergency situation exists ; and
following guidance from said computer to said nearby airport.

11. The method of claim 10, wherein said notifying step is carried out by sending an airspeed indication of 911 knots over said ADS-B system.

12. The method of claim 11, wherein said sending step is carried out by an occupant of said aircraft pressing a button on a touch screen tablet.

13. The method of claim 11, wherein said sending step is carried out by an occupant of said aircraft engaging a switch.

14. The method of claim 12, wherein said guidance from said computer includes instructions from said computer presented on a touch screen tablet in communication therewith.

15. The method of claim 14, wherein said instructions are audio instructions.

16. The method of claim 14, wherein said instructions are video instructions.

17. The method of claim 11, wherein said following step is carried out by an autopilot on board said aircraft.

18. The method of claim 11, including an additional step of rerouting aircraft out of paths conflicting with said aircraft.

19. A method for handling an emergency situation in an unmanned aerial vehicle when control of said vehicle has become in jeopardy because of ground to air communication failure, the method comprising the steps of:
identifying a control emergency;
sending a signal to an emergency computer on board the aircraft;
using said computer to compute a desired course to a nearby airport;
using ADS-B to notify ATC that an emergency situation exists; and
following guidance from said computer to said nearby airport.
